(19) United States
(12) Patent Application Publication
(10) Pub. No.: US 2025/0309660 A1
(43) Pub. Date: Oct. 2, 2025

(54) Household load power supply method and household load power supply device, and battery charge method and battery charge device

(71) Applicant: Huizhou ROYPOW Technology Co., Ltd., Huizhou (CN)

(72) Inventors: Xiaokun XIE, Huizhou (CN); Zuyin KONG, Huizhou (CN); Wei FU, Huizhou (CN); Quanfu ZOU, Huizhou (CN); Zhimin QIN, Huizhou (CN)

(73) Assignee: Huizhou ROYPOW Technology Co., Ltd., Huizhou (CN)

(21) Appl. No.: 19/004,303

(22) Filed: Dec. 28, 2024

(30) Foreign Application Priority Data
Apr. 1, 2024 (CN) 202410384271.5

(51) Int. Cl. H02J 7/00; H02J 3/32

(52) U.S. Cl. CPC H02J 7/0014; H02J 3/32; H02J 7/0048; H02J 7/005; H02J 7/0063; H02J 2310/12

(57) ABSTRACT

A household load power supply method and a battery charge method are provided. A central controller can allocate a discharge power for each battery according to a required total discharge power, a state-of-charge data and state-of-heath data of n batteries, and the discharge power for each battery is proportional to the state-of-charge data and state-of-heath data of the each battery. A sum of discharge powers allocated to the n batteries is equal to the total discharge power. In this way, a battery with higher state-of-charge data and higher state-of-heath data can have higher discharge power, and the battery with higher state-of-heath data can have higher discharge power. Two dimensions, that is, the state-of-charge data and state-of-heath data are comprehensively considered, and thus the discharge powers allocated to the batteries are more reasonably and balanced, thereby extending an overall service life of a plurality of batteries in parallel.

### CROSS-REFERENCE TO RELATED APPLICATION

The present application claims priority to Chinese patent application No. 2024103842715, filed on Apr. 1, 2024, the disclosure of which is hereby incorporated by reference in its entirety.

### BACKGROUND

Currently, a plurality of batteries in parallel can be disposed in a household load power supply system, and a power grid can be used to charge the plurality of batteries in parallel based on a same charge power, so that the plurality of batteries in parallel can be used to power household loads when needed. Alternatively, the plurality of batteries in parallel can be used to discharge to a power grid when it is needed. However, for the plurality of batteries in parallel, the state-of-charge (State of Charge, SOC) data of batteries are different, and/or the state-of-health (state of health, SOH) data of the batteries are different. In a condition that a total charge power remains unchanged, if the batteries each are initially charged with a same charge power, the batteries with higher state-of-charge data will complete charging first, and the batteries with lower state-of-charge data will continue to be charged with a particularly high charge power, thereby affecting service lives of the batteries with lower state-of-charge data. Furthermore, in a condition that the total charge power remains unchanged, if the batteries each are initially charged with the same charge power, the service lives of the batteries with low state-of-heath data will be greatly affected. The service lives of the battery with low state-of-heath data are affected, thereby resulting in a low overall service life of the plurality of batteries in parallel. Similarly, if a plurality of batteries in parallel are discharged with a same discharge power, it will also result in the low overall service life of the plurality of batteries in parallel.

### SUMMARY

The disclosure relates to the field of battery technology, and in particular to a household load power supply method and a household load power supply device, and a battery charge method and a battery charge device.

A household load power supply method and a household load power supply device, and a battery charge method and a battery charge device are provided according to the disclosure, which are used to solve a problem in some implementations that a plurality of batteries in parallel are charged or discharged, resulting in a low overall service life of the plurality of batteries in parallel.

In a first aspect, a household load power supply method is provided according to an embodiment of the disclosure, which is applied to a central controller which belongs to a household load power supply system; where the household load power supply system further includes n power supply branches in parallel, each of which includes a battery and a power regulation module that are connected in series; the central controller is electrically connected to each power regulation module, respectively, n being an integer greater than 1. The household load power supply method provided according to an embodiment of the disclosure includes:
obtaining, by the central controller when receiving a discharge instruction transmitted by a user terminal, state-of-charge data and state-of-heath data of n batteries;
allocating, by the central controller according to a required total discharge power and the state-of-charge data and state-of-heath data of n batteries, a discharge power for each battery, wherein the discharge power for each battery is proportional to the state-of-charge data and state-of-heath data of each battery; and a sum of discharge powers allocated to the n batteries is equal to the total discharge power; and
controlling, by the central controller, each power regulation module to make a corresponding battery to discharge to a power grid in accordance with a discharge power allocated to the corresponding battery.

In a possible embodiment, the allocating, by the central controller according to the required total discharge power and the state-of-charge data and state-of-heath data of the n batteries, the discharge power for each battery, includes:

determining, by the central controller when the state-of-charge data of various batteries are not equal and the state-of-heath data of various batteries are not equal, an allocation ratio of discharge power for each battery according to a formula (1−SOC₁×SOH₁)×K₁=(1−SOC₂ ×SOH₂)×K₂= . . . =(1−SOC)×SOHₙ)×Kₙ, where, SOC₁ is a state-of-charge data of a first battery; SOH₁ is a state-of-heath data of the first battery; k₁ is an allocation ratio of discharge power for the first battery; SOC₂ is a state-of-charge data of a second battery; SOH₂ is a state-of-heath data of the second battery; k₂ is an allocation ratio of discharge power for the second battery; SOCₙ is a state-of-charge data of a n^{th} battery; SOHₙ is a state-of-heath data of the n^{th} battery; and kₙ is an allocation ratio of discharge power for the n^{th} battery;
allocating the discharge power for each battery according to the allocation ratio of discharge power for each battery and the total discharge power.

In a possible embodiment, the determining, by the central controller according to the formula (1−SOC₁×SOH₁)×K₁=(1−SOC₂×SOH₂)×K₂= . . . =(1−SOC)×SOHₙ)×Kₙ, the allocation ratio of discharge power for each battery includes:
determining, by the central controller according to a formula (1−SOC₁×SOH₁)×K₁=(1−SOC_{2×}SOH₂)×K₂= . . . =(1−SOC)×SOHₙ)×Kₙ, an allocation ratio of discharge current/discharge voltage for each battery; and
determining, by the central controller, the allocation ratio of discharge current/discharge voltage for each battery as the allocation ratio of discharge power for each battery.

In a possible embodiment, the allocating, by the central controller according to the required total discharge power and the state-of-charge data and state-of-heath data of the n batteries, the discharge power for each battery, includes:
determining, by the central controller when the state-of-heath data of various batteries are equal and the state-of-charge data of various batteries are not equal, an allocation ratio of discharge power for each battery according to a formula (1−SOC₁)×K₁=(1−SOC₂)×K₂= . . . =(1−SOCn)×Kₙ, where SOC₁ is a state-of-charge data of a first battery; k₁ is an allocation ratio of discharge power for the first battery; SOC₂ is a state-of-charge data of a second battery; k₂ is an allocation ratio of discharge power for the second battery; SOC, is a state-of-charge data of a n^{th} battery; and kₙ is an allocation ratio of discharge power for the n^{th} battery.

In a possible embodiment, the allocating, by the central controller according to the required total discharge power and the state-of-charge data and state-of-heath data of the n batteries, the discharge power for each battery includes:
determining, by the central controller when the state-of-charge data of various batteries are equal and the state-of-heath data of various batteries are not equal, an allocation ratio of discharge power for each battery according to a formula (1−SOH₁)×K₁=(1−SOH₂)×K₂= . . . =(1−SOHₙ)×Kₙ, where SOH₁ is a state-of-heath data of a first battery; k₁ is an allocation ratio of discharge power for the first battery; SOH₂ is a state-of-heath data of a second battery; k₂ is an allocation ratio of discharge power for the second battery; SOHₙ is a state-of-heath data of a n^{th} battery; and kₙ is an allocation ratio of discharge power for the n^{th} battery.

In a second aspect, a battery charge method is provided according to an embodiment of the disclosure, which is applied to a central controller, which belongs to a household load power supply system; the household load power supply system further includes n power supply branches in parallel, each of which comprises a battery and a power regulation module that are connected in series; the central controller is electrically connected to each power regulation module respectively, n being an integer greater than 1, and the method includes:
obtaining, by the central controller when receiving a charge instruction transmitted by a user terminal, state-of-charge data and state-of-heath data of n batteries;
allocating, by the central controller according to a required total charge power and the state-of-charge data and state-of-heath data of n batteries, a charge power for each battery, wherein the charge power for the each battery is inversely proportional to the state-of-charge data and the charge power for the each battery is proportional to state-of-heath data of the each battery, and wherein a sum of charge powers allocated to the n batteries is equal to a total charge power;
controlling each power regulation module, by the central controller, to charge a corresponding battery with an electric energy output by a power grid in accordance with a charge power allocated to the corresponding battery.

In a possible embodiment, the allocating, by the central controller according to the required total charge power and the state-of-charge data and state-of-heath data of the n batteries, the charge power for each battery includes:
determining, by the central controller when the state-of-charge data of various batteries are not equal and the state-of-heath data of various batteries are not equal, an allocation ratio of charge power for each battery according to a formula SOC₁×(1−SOH₁)×W₁=SOC₂×(1−SOH₂)×W₂= . . . =SOCₙ×(1−SOHₙ)×Wₙ, where, SOC₁ is a state-of-charge data of a first battery; SOH₁ is a state-of-heath data of the first battery; W₁ is an allocation ratio of charge power for the first battery; SOC₂ is a state-of-charge data of a second battery; SOH₂ is a state-of-heath data of the second battery; W₂ is an allocation ratio of charge power for the second battery; SOCₙ is a state-of-charge data of a n^{th} battery; SOHₙ is a state-of-heath data of the n^{th} battery; and Wₙ is an allocation ratio of charge power for the n^{th} battery.

In a possible embodiment, the allocating, by the central controller according to the required total charge power and the state-of-charge data and state-of-heath data of the n batteries, the charge power for each battery, includes:

determining, by the central controller when the state-of-charge data of various batteries are equal and the state-of-heath data of various batteries are not equal, an allocation ratio of charge power for each battery according to a formula (1−SOH₁)×W₁=(1−SOH₂)×W₂= . . . =(1−SOHₙ)×Wₙ, where SOH₁ is a state-of-heath data of a first battery; W₁ is an allocation ratio of charge power for the first battery; SOH₂ is a state-of-heath data of a second battery; W₂ is an allocation ratio of charge power for the second battery; SOCₙ is a state-of-charge data of a n^{th} battery; and Wₙ is an allocation ratio of charge power for the n^{th} battery.

In a possible embodiment, the allocating, by the central controller according to the required total charge power and the state-of-charge data and state-of-heath data of the n batteries, the charge power for each battery, includes:
determining, by the central controller when the state-of-heath data of various batteries are equal and the state-of-charge data of various batteries are not equal, an allocation ratio of charge power for each battery according to a formula SOC₁×W₁=SOC₂×W₂= . . . =SOCₙ×Wₙ, where SOC₁ is a state-of-charge data of a first battery; W₁ is an allocation ratio of charge power for the first battery; SOC₂ is a state-of-charge data of a second battery; W₂ is an allocation ratio of charge power for the second battery; SOCₙ is a state-of-charge data of as n^{th} battery; and Wₙ is an allocation ratio of charge power for the n^{th} battery.

In a third aspect, a household load control apparatus is also provided according to an embodiment of the disclosure. The apparatus includes a a household load power supply device which is configured at a central controller, which belongs to a household load power supply system; the household load power supply system further includes n power supply branches in parallel, each of which comprises a battery and a power regulation module that are connected in series; and the central controller is electrically connected to each power regulation module respectively, n being an integer greater than 1. The household load power supply device provided according to an embodiment of the disclosure includes:
a first data acquisition unit, when receiving a discharge instruction transmitted by a user terminal, configured to obtain state-of-charge data and state-of-heath data of n batteries;
a first power allocation unit, configured to allocate a discharge power for each battery according to a required total discharge power and the state-of-charge data and state-of-heath data of n batteries, and wherein the discharge power for each battery is proportional to the state-of-charge data and state-of-heath data of the each battery, and wherein a sum of discharge powers allocated to the n batteries is equal to the total discharge power;
a first battery discharge unit, configured to control each power regulation module to make a corresponding battery to discharge to a power grid in accordance with a discharge power allocated to the corresponding battery.

In a possible embodiment, the household load control apparatus further includes a battery charge device, which is configured at the central controller. The battery charge device provided according to an embodiment of the disclosure includes:
a second data acquisition unit, when receiving a charge instruction transmitted by a user terminal, configured to obtain state-of-charge data and state-of-heath data of n batteries;
a second power allocation unit, configured to allocate a charge power for each battery according to a required total charge power and the state-of-charge data and state-of-heath data of n batteries, and where the charge power for the each battery is inversely proportional to the state-of-charge data of the each battery and the charge power for the each battery is proportional to the state-of-heath data of the each battery, and where a sum of charge powers allocated to the n batteries is equal to a total charge power;
a second battery charge unit, configured to control each power regulation module to charge a corresponding battery with an electric energy output by a power grid in accordance with a charge power allocated to the corresponding battery.

A household load power supply method and a household load power supply device, and a battery charge method and a household load control apparatus are provided according to the disclosure. A central controller can allocate a discharge power for each battery according to a required total discharge power and the state-of-charge data and state-of-heath data of n batteries, and the discharge power for each battery is proportional to the state-of-charge data and state-of-heath data of the each battery. A sum of discharge powers allocated to the n batteries is equal to the total discharge power. In this way, a battery with higher state-of-charge data and higher state-of-heath data can have higher discharge power, and the battery with higher state-of-heath data can have higher discharge power; conversely, a battery with lower state-of-charge data and lower state-of-heath data has lower discharge power. Two dimensions, that is, the state-of-charge data and state-of-heath data are comprehensively considered, and thus the discharge powers allocated to the batteries are more reasonably and balanced, thereby extending an overall service life of a plurality of batteries in parallel.

Further, the central controller can also allocate a charge power for each battery according to a required total charge power and the state-of-charge data and state-of-heath data of n batteries. The charge power for each battery is inversely proportional to the state-of-charge data of the each battery and the charge power for the each battery is proportional to the state-of-heath data of the each battery. A sum of charge powers allocated to the n batteries is equal to a total charge power. In this way, a battery with higher state-of-charge data can have a lower charge power, and the battery with higher state-of-heath data can have higher charge power; conversely, a battery with lower state-of-charge data has higher charge power, and a battery with lower state-of-heath data has lower charge power. Two dimensions, that is, the state-of-charge data and state-of-heath data are comprehensively considered, and thus the charge powers allocated to the batteries are more reasonably and balanced, thereby extending an overall service life of a plurality of batteries in parallel.

### BRIEF DESCRIPTION OF DRAWINGS

In order to more clearly illustrate the technical solutions in the embodiments of the disclosure or the technical solutions in some implementations, the accompanying drawings required for use in the description of the embodiments or for use in the description of the technical solutions in some implementations will be briefly introduced in the following. Obviously, the accompanying drawings described below are some embodiments of the disclosure. For those skilled in the art, other accompanying drawings can be obtained based on these drawings without creative work.

FIG. 1 is a schematic diagram showing interaction of various components within a household load power supply system according to an embodiment of the disclosure;

FIG. 2 is a flow chart of a household load power supply method according to an embodiment of the disclosure;

FIG. 3 is a flow chart of a battery charge method according to an embodiment of the disclosure;

FIG. 4 is a functional module block diagram of a household load power supply device according to an embodiment of the disclosure; and

FIG. 5 is a functional module block diagram of a battery charge device according to an embodiment of the disclosure.

### DETAILED DESCRIPTION

Hereinafter, embodiments of the disclosure will be described with reference to the accompanying drawings. It should be understood, however, that these descriptions are illustrative only and are not intended to limit a scope of the disclosure. Furthermore, in the following description, descriptions of well-known structures and technologies are omitted to avoid unnecessarily obscuring concepts in the disclosure.

The accompanying drawings show various structural schematic diagrams according to embodiments of the disclosure. The accompanying drawings are not drawn to scale. Some details may be exaggerated and some details may be omitted, for clarity of presentation. Shapes of various regions and layers shown in the accompanying drawings and relative sizes and positions of the various regions and layers are merely illustrative and may deviate in practice due to manufacturing tolerances or technical limitations. Those skilled in the art may also design regions/layers with different shapes, sizes and relative positions according to actual needs.

In the context of the disclosure, when a layer/element is referred to as being “on” another layer/element, the layer/element can be directly on the another layer/element or an intervening layer/element may be present therebetween. In addition, if a layer/element is “on” another layer/element in an orientation, then when the orientation is reversed, the layer/element may be “below” the another layer/element.

The following is a detailed description of the technical solutions of the disclosure and how the technical solutions of the disclosure solve the above-mentioned technical problems according to the embodiments of the disclosure. The following embodiments may be combined with each other, and the same or similar concepts or processes may not be described in detail in some embodiments. The embodiments of the disclosure will be described below in conjunction with the accompanying drawings.

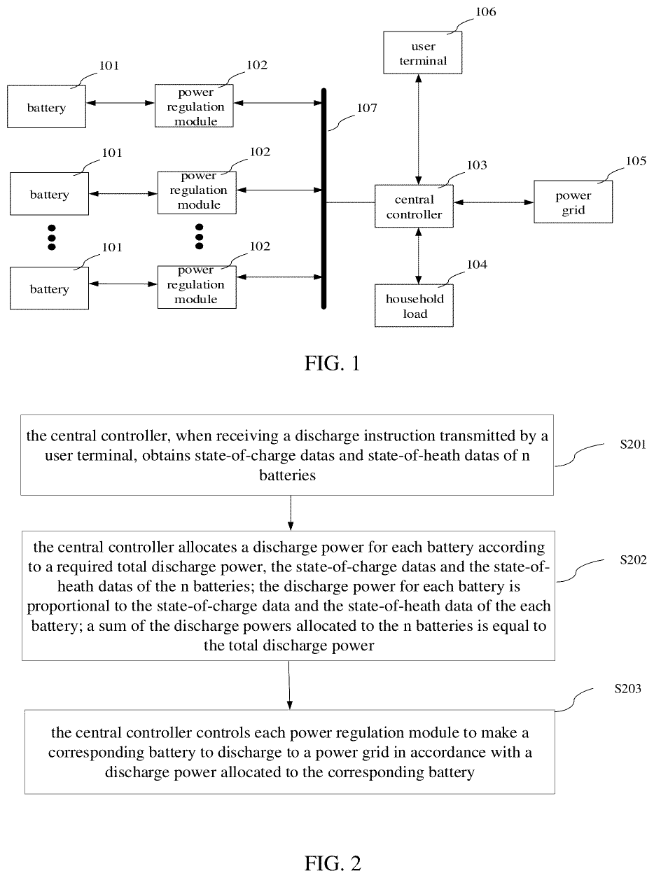

A household load power supply method is provided according to some embodiments of the disclosure, which is applied to a central controller 103. As shown in FIG. 1, the central controller 103 belongs to a household load power supply system. The household load power supply system also includes n power supply branches in parallel, each of which includes a battery 101 and a power regulation module 102 that are connected in series. The central controller 103 may be electrically connected to each power regulation module 102 respectively through a DC bus 107. The n is an integer greater than 1. In some embodiments, n may be equal to 2 or 3 or the like. The power regulation module 102 may be but not limited to a DC regulation module. The central controller 103 may be disposed in an inverter. The inverter is an electrical device that changes a voltage, frequency, number of phases and other electrical quantities or characteristics of a power supply system. In some embodiments, the central controller 103 is also electrically connected to a household load 104 (such as an air conditioner, a refrigerator and the like.), a power grid 105, and a user terminal 106 (such as a mobile phone, a computer). As shown in FIG. 2, a method according to an embodiment of the disclosure includes Step S201-Step 203.

In Step S201, the central controller 103, when receiving a discharge instruction transmitted by a user terminal 106, obtains state-of-charge data and state-of-heath data of n batteries 101.

In some embodiments, when a power grid 105 is in a peak state of power consumption, a user can trigger the user terminal 106 to send a discharge instruction to the central controller 103. The central controller 103, when receiving the discharge instruction transmitted by the user terminal 106, can obtain state-of-charge data and state-of-heath data of n batteries 101 via the DC bus 107 and the power regulation module 102.

In Step S202, the central controller 103 allocates a discharge power for each battery 101 according to a required total discharge power, the state-of-charge data and the state-of-heath data of the n batteries 101. The discharge power for each battery 101 is proportional to the state-of-charge data and the state-of-heath data of the each battery 101. A sum of the discharge powers allocated to the n batteries 101 is equal to the total discharge power.

In some embodiments, specific implementation of Step S202 includes but is not limited to the following three ways.

The first way: the central controller 103, when the state-of-charge data of various batteries 101 are not equal and the state-of-heath data of various batteries 101 are not equal, determines an allocation ratio of discharge power for each battery 101 according to a formula (1−SOC₁×SOH₁)×K₁=(1−SOC_{2×}SOH₂)×K₂= . . . =(1−SOCₙ×SOHₙ)×Kₙ, where, SOC₁ is a state-of-charge data of a first battery 101; SOH₁ is a state-of-heath data of the first battery 101; k₁ is an allocation ratio of discharge power for the first battery 101; SOC₂ is a state-of-charge data of a second battery 101; SOH₂ is a state-of-heath data of the second battery 101; k₂ is an allocation ratio of discharge power for the second battery 101; SOCₙ is a state-of-charge data of a n^{th} battery 101; SOHₙ is a state-of-heath data of the n^{th} battery 101; and kₙ is an allocation ratio of discharge power for the n^{th} battery 101. The discharge power for each battery 101 is allocated according to the allocation ratio of discharge power for each battery 101 and the total discharge power.

In some embodiments, if n=2, the allocation ratio of discharge power for each battery 101 is determined according to (1−SOC₁×SOH₁)×K₁=(1−SOC_{2×}SOH₂)×K₂. If SOC_{1×}SOH₁₌₅₀%, and SOC₂×SOH₂₌₇₀%, then an allocation ratio K₁ of discharge power for a battery 1 is 3 parts, and an allocation ratio K₂ of discharge power for a battery 2 is 5 parts. It is assumed that a required total discharge power is 20 KW, then the discharge power allocated to the battery 1 is 7.5 kw, and the discharge power allocated to the battery 2 is 12.5 kw, that is, a ratio of the discharge power allocated to battery 1 to the discharge power allocated to battery 2 is 3/5.

Further, the allocation ratio of discharge power for each battery 101 is determined according to (1−SOC₁×SOH₁)×K₁(1−SOC_{2×}SOH₂)×K₂, and may be specifically shown in the following Table 1.

TABLE 1

| | Allocation | SOC × SOH (%) of battery 1 | | | | | | | | |
|---|---|---|---|---|---|---|---|---|---|---|
| | ratio | 10% | 20% | 30% | 40% | 50% | 60% | 70% | 80% | 90% |
| SOC × SOH | 10% | 1.0000 | 0.5000 | 0.3333 | 0.2500 | 0.2000 | 0.1667 | 0.1428 | 0.1250 | 0.1111 |
| (%) | 20% | 2.0000 | 1.0000 | 0.6667 | 0.5000 | 0.4000 | 0.3333 | 0.2857 | 0.2500 | 0.2222 |
| of | 30% | 3.0000 | 1.5000 | 1.0000 | 0.7500 | 0.8000 | 0.5000 | 0.4286 | 0.3750 | 0.3333 |
| battery | 40% | 4.0000 | 2.0000 | 1.3333 | 1.0000 | 0.8000 | 0.6667 | 0.5714 | 0.5000 | 0.4444 |
| 2 | 50% | 5.0000 | 2.5000 | 1.6667 | 1.2500 | 1.0000 | 0.8333 | 0.7143 | 0.6250 | 0.5556 |
| | 60% | 6.0000 | 3.0000 | 2.0000 | 1.5000 | 1.2000 | 1.0000 | 0.8571 | 0.7500 | 0.6667 |
| | 70% | 7.0000 | 3.5000 | 2.3333 | 1.7500 | 1.4000 | 1.1667 | 1.0000 | 0.8750 | 0.7778 |
| | 80% | 8.0000 | 4.0000 | 2.6667 | 2.0000 | 1.6000 | 1.3333 | 1.0000 | 1.0000 | 0.8889 |
| | 90% | 9.0000 | 4.5000 | 3.0000 | 2.2500 | 1.8000 | 1.5000 | 1.2857 | 1.1250 | 1.0000 |

Furthermore, the central controller 103 determines an allocation ratio of discharge current/discharge voltage for each battery 101 according to a formula (1−SOC₁×SOH₁)×K₁=(1−SOC_{2×}SOH₂)×K₂= . . . =(1−SOCₙ×SOHₙ)×Kₙ; and the central controller 103 determines the allocation ratio of discharge current/discharge voltage for each battery 101 as the allocation ratio of discharge power for each battery 101, where, (1−SOC₁×SOH₁)×K₁, (1−SOC_{2×}SOH₂) x K₂, and (1−SOCₙ×SOHₙ)×Kₙ may be understood as a weighted current, a weighted voltage or a weighted power for each battery 101, respectively, which is not limited here.

The second way: the central controller 103, when the state-of-heath data of various batteries 101 are equal and the state-of-charge data of various batteries 101 are not equal, determines an allocation ratio of discharge power for each battery 101 according to a formula (1−SOC₁)×K₁=(1−SOC₂)×K₂ . . . (1−SOCₙ)×Kₙ, where SOC₁ is a state-of-charge data of a first battery 101; k₁ is an allocation ratio of discharge power for the first battery 101; SOC₂ is a state-of-charge data of a second battery 101; k₂ is an allocation ratio of discharge power for the second battery 101; SOCₙ is a state-of-charge data of a n^{th} battery 101; and kₙ is an allocation ratio of discharge power for the n^{th} battery 101.

It should be noted that a principle of the second way is similar to that of the first way mentioned above, and will not be elaborated here.

The third way: the central controller 103, when the state-of-charge data of various batteries 101 are equal and the state-of-heath data of various batteries 101 are not equal, determines an allocation ratio of discharge power for each battery 101 according to a formula (1−SOH₁)×K₁=(1−SOH₂)×K₂= . . . =(1−SOHₙ)×Kₙ, where SOH₁ is a state-of-heath data of a first battery 101; k₁ is an allocation ratio of discharge power for the first battery 101; SOH₂ is a state-of-heath data of a second battery 101; k₂ is an allocation ratio of discharge power for the second battery 101; SOHₙ is a state-of-heath data of a n^{th} battery 101; and kₙ is an allocation ratio of discharge power for the n^{th} battery 101.

It should be noted that a principle of the third way is similar to that of the first type of way mentioned above, and will not be elaborated here.

In Step S203: the central controller 103 controls each power regulation module 102 to make a corresponding battery 101 to discharge to a power grid 105 in accordance with a discharge power allocated to the corresponding battery 101.

A household load power supply method is provided according to according to an embodiment of the disclosure. A central controller 103 can allocate a discharge power for each battery 101 according to the required total discharge power, the state-of-charge data and state-of-heath data of n batteries 101. The discharge power for each battery 101 is proportional to the state-of-charge data and state-of-heath data of each battery 101. A sum of discharge powers allocated to the n batteries 101 is equal to the total discharge power. In this way, a battery 101 with higher state-of-charge data and higher state-of-heath data can have higher discharge power, and the battery 101 with higher state-of-heath data can have higher discharge power. Conversely, a battery 101 with lower state-of-charge data and lower state-of-heath data has lower discharge power. Two dimensions, i.e., the state-of-charge data and state-of-heath data, are comprehensively considered, and thus the discharge powers allocated to the batteries 101 are more reasonably and balanced, thereby extending an overall service life of a plurality of batteries 101 in parallel.

In some embodiments, a battery charge method is provided according to an embodiment of the disclosure, which is applied to the central controller 103. As shown in FIG. 1, the central controller 103 belongs to a household load power supply system. The household load power supply system also includes n power supply branches in parallel, each of which includes a battery 101 and a power regulation module 102 that are connected in series. The central controller 103 may be electrically connected to each power regulation module 102 respectively. The n is an integer greater than 1. As shown in FIG. 3, a method according to an embodiment of the disclosure includes Step 301-Step 303.

In Step S301, the central controller 103, when receiving a charge instruction transmitted by a user terminal 106, obtains state-of-charge data and state-of-heath data of n batteries 101.

In some embodiments, when a power grid 105 is in a low state of power consumption, a user can trigger the user terminal 106 to send a charge instruction to the central controller 103. The central controller 103, when receiving the charge instruction transmitted by the user terminal 106, can obtain state-of-charge data and state-of-heath data of n batteries 101 via the DC bus 107 and the power regulation module 102.

In Step S302, a central controller 103 allocates a charge power for each battery 101 according to a required total charge power and the state-of-charge data and state-of-heath data of n batteries 101; the charge power for each battery 101 is inversely proportional to the state-of-charge data of the each battery and the charge power for the each battery is proportional to the state-of-heath data of the each battery; and a sum of charge powers allocated to the n batteries 101 is equal to a total charge power.

In some embodiments, a specific implementation of Step S302 includes but is not limited to the following two ways.

The first way: the central controller 103, when the state-of-charge data of various batteries 101 are not equal and the state-of-heath data of various batteries 101 are not equal, determines an allocation ratio of charge power for each battery 101 according to a formula SOC₁×(1−SOH₁)×W₁₌SOC₂×(1−SOH₂)×W₂= . . . =SOCₙ×(1−SOHₙ)×Wₙ, where, SOC₁ is a state-of-charge data of a first battery 101; SOH₁ is a state-of-heath data of the first battery 101; W₁ is an allocation ratio of charge power for the first battery 101; SOC₂ is a state-of-charge data of a second battery 101; SOH₂ is a state-of-heath data of the second battery 101; W₂ is an allocation ratio of charge power for the second battery 101; SOCₙ is a state-of-charge data of a n^{th} battery 101; SOHₙ is a state-of-heath data of the n^{th} battery 101, and Wₙ is an allocation ratio of charge power for the n^{th} battery 101.

The second way: the central controller 103, when the state-of-charge data of various batteries 101 are equal and the state-of-heath data of various batteries 101 are not equal, determines an allocation ratio of charge power for each battery 101 according to a formula (1−SOH₁)×W₁=(1−SOH₂)×W₂= . . . =(1−SOHₙ)×Wₙ, where SOH₁ is a state-of-heath data of a first battery 101; W₁ is an allocation ratio of charge power for the first battery 101; SOH₂ is a state-of-heath data of a second battery 101; W₂ is an allocation ratio of charge power for the second battery 101; SOCₙ is a state-of-charge data of a n^{th} battery 101; and Wₙ is an allocation ratio of charge power for the n^{th} battery 101.

The third way: the central controller 103, when the state-of-heath data of various batteries 101 are equal and the state-of-charge data of various batteries 101 are not equal, determines an allocation ratio of charge power for each battery 101 according to a formula SOC_{1×}W₁₌SOC_{2×}W₂= . . . =SOCₙ×Wₙ, where SOC₁ is a state-of-charge data of a first battery 101; W₁ is an allocation ratio of charge power for the first battery 101; SOC₂ is a state-of-charge data of a second battery 101; W₂ is an allocation ratio of charge power for the second battery 101; SOCₙ is a state-of-charge data of a n^{th} battery 101; and Wₙ is an allocation ratio of charge power for the n^{th} battery 101.

It can be understood that a working principle of step S302 is similar to that of step S202 described above, and will not be elaborated here.

In Step S303, the central controller 103 controls each power regulation module 102 to charge a corresponding battery 101 with an electric energy output by a power grid 105 in accordance with a charge power allocated to the corresponding battery 101.

With a battery charge method according to an embodiment of the disclosure, the central controller 103 can also allocate a charge power for each battery 101 according to a required total charge power and the state-of-charge data and state-of-heath data of n batteries 101. The charge power for each battery 101 is inversely proportional to the state-of-charge data of the each battery and the charge power for the each battery is proportional to the state-of-heath data of the each battery. A sum of charge powers allocated to the n batteries 101 is equal to a total charge power. In this way, a battery 101 with higher state-of-charge data can have a lower charge power, and the battery 101 with higher state-of-heath data can have higher charge power. Conversely, a battery 101 with lower state-of-charge data has higher charge power, and a battery 101 with lower state-of-heath data has lower charge power. Two dimensions, i.e., the state-of-charge data and state-of-heath data, are comprehensively considered, and thus the charge powers allocated to the batteries 101 are more reasonably and balanced, thereby extending an overall service life of a plurality of batteries 101 in parallel.

A household load control apparatus is provided according to an embodiment of the disclosure, the apparatus includes a a household load power supply device. In some embodiments, he apparatus further includes a battery charge device.

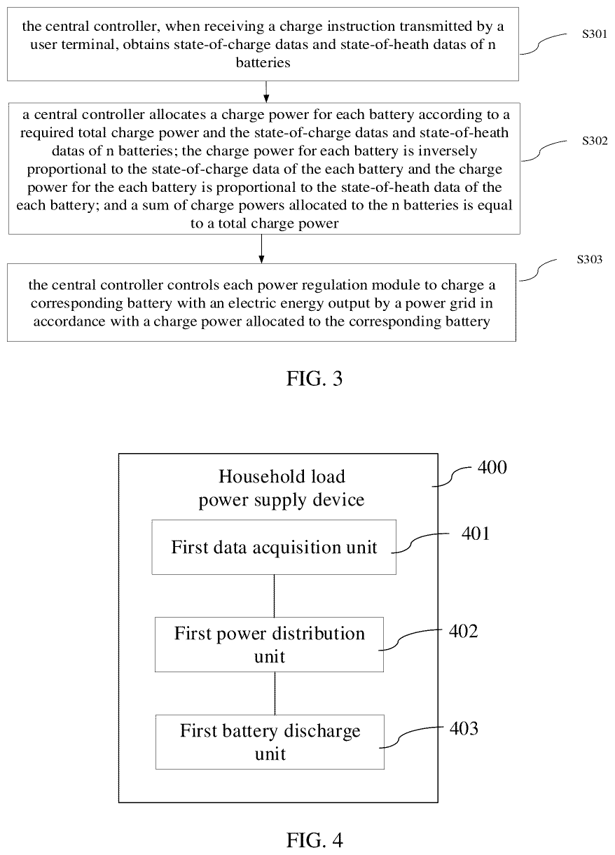

Referring to FIG. 4, a household load power supply device 400 is further provided according to an embodiment of the disclosure and is configured at the central controller 103. The central controller 103 belongs to the household load power supply system. It should be noted that a basic principle and technical effects of the household load power supply device 400 provided according to an embodiment of the disclosure are the same as those in the above embodiments. For the sake of brief description, for portions not mentioned in the embodiment, reference may be made to the corresponding contents in the above embodiments. The household load power supply system also includes n power supply branches in parallel, each of which includes a battery 101 and a power regulation module 102 that are connected in series. The central controller 103 may be electrically connected to each power regulation module 102 respectively. The n is an integer greater than 1. The device 400 according to an embodiment of the disclosure includes a first data acquisition unit 401, a first power allocation unit 402, and a first battery discharge unit 403.

The first data acquisition unit 401 is configured, when receiving a discharge instruction transmitted by a user terminal 106, to obtain state-of-charge data and state-of-heath data of n batteries 101.

The first power allocation unit 402 is configured to allocate a discharge power for each battery 101 according to a required total discharge power and the state-of-charge data and state-of-heath data of n batteries 101. The discharge power for each battery 101 is proportional to the state-of-charge data and state-of-heath data of the each battery 101. A sum of discharge powers allocated to the n batteries 101 is equal to the total discharge power.

The first battery discharge unit 403 is configured to control each power regulation module 102 to make a corresponding battery 101 to discharge to a power grid 105 in accordance with a discharge power allocated to the corresponding battery 101.

In a possible embodiment, the central controller 103 allocates the discharge power for each battery 101 according to the required total discharge power, the state-of-charge data and the state-of-heath data of the n batteries 101, including that:

the central controller 103, when the state-of-charge data of various batteries 101 are not equal and the state-of-heath data of various batteries 101 are not equal, determines an allocation ratio of discharge power for each battery 101 according to a formula (1−SOC₁×SOH₁)×K₁=(1−SOC₂×SOH₂)×K₂= . . . =(1−SOCₙ×SOHₙ)×Kₙ, where, SOC₁ is a state-of-charge data of a first battery 101; SOH₁ is a state-of-heath data of the first battery 101; k₁ is an allocation ratio of discharge power for the first battery 101; SOC₂ is a state-of-charge data of a second battery 101; SOH₂ is a state-of-heath data of the second battery 101; k₂ is an allocation ratio of discharge power for the second battery 101; SOCₙ is a state-of-charge data of a n^{th} battery 101; SOHₙ is a state-of-heath data of the n^{th} battery 101; and kₙ is an allocation ratio of discharge power for the n^{th} battery 101.

The discharge power for each battery 101 is allocated according to the allocation ratio of discharge power for each battery 101 and the total discharge power.

In some embodiments, the first power allocation unit 402 is specifically configured to determine the allocation ratio of discharge current/discharge voltage for each battery 101 according to a formula (1−SOC₁×SOH₁)×K₁=(1−SOC₂×SOH₂)×K₂= . . . =(1-SOCₙ×SOHₙ)×Kₙ; and determine the allocation ratio of discharge current/discharge voltage for each battery 101 as the allocation ratio of discharge power for each battery 101.

In a possible embodiment, the first power allocation unit 402 is further specifically configured to determine, when the state-of-heath data of various batteries 101 are equal and the state-of-charge data of various batteries 101 are not equal, an allocation ratio of discharge power for each battery 101 according to a formula (1−SOC₁)×K₁=(1−SOC₂)×K₂= . . . = (1-SOCₙ)×Kₙ, where SOC₁ is a state-of-charge data of a first battery 101; k₁ is an allocation ratio of discharge power for the first battery 101; SOC₂ is a state-of-charge data of a second battery 101; k₂ is an allocation ratio of discharge power for the second battery 101; SOCₙ is a state-of-charge data of a n^{th} battery 101; and kₙ is an allocation ratio of discharge power for the n^{th} battery 101.

In a possible embodiment, the first power allocation unit 402 is further specifically configured to determine, when the state-of-charge data of various batteries 101 are equal and the state-of-heath data of various batteries 101 are not equal, an allocation ratio of discharge power for each battery 101 according to a formula (1−SOH₁)×K₁−(1−SOH₂)×K₂= . . . =(1−SOHₙ)×Kₙ, where SOH₁ is a state-of-heath data of a first battery 101; k₁ is an allocation ratio of discharge power for the first battery 101; SOH₂ is a state-of-heath data of a second battery 101; k₂ is an allocation ratio of discharge power for the second battery 101; SOHₙ is a state-of-heath data of a n^{th} battery 101; and kₙ is an allocation ratio of discharge power for the n^{th} battery 101.

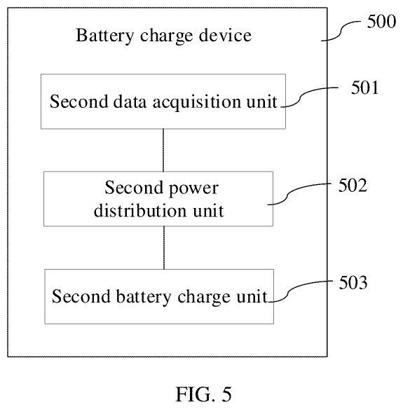

In some embodiments, a battery charge device 500 is also provided according to an embodiment of the disclosure and is configured at the central controller 103. The central controller 103 belongs to the household load power supply system. It should be noted that a basic principle and technical effects of the battery charge device 500 provided according to an embodiment of the disclosure are the same as those in the above embodiments. For the sake of brief description, for portions not mentioned in the embodiment, reference may be made to the corresponding contents in the above embodiment. The household load power supply system also includes n power supply branches in parallel, each of which includes a battery 101 and a power regulation module 102 that are connected in series. The central controller 103 may be electrically connected to each power regulation module 102 respectively. The n is an integer greater than 1. As shown in FIG. 5, the device 500 according to an embodiment of the disclosure includes a second data acquisition unit 501, a second power allocation unit 502 and a second battery charge unit 503.

The second data acquisition unit 501 is configured, when receiving a charge instruction transmitted by a user terminal 106, to obtain state-of-charge data and state-of-heath data of n batteries 101.

The second power allocation unit 502 is configured to allocate a charge power for each battery 101 according to a required total charge power and the state-of-charge data and state-of-heath data of n batteries 101. The charge power for each battery 101 is inversely proportional to the state-of-charge data of the each battery and the charge power for the each battery is proportional to the state-of-heath data of the each battery. A sum of charge powers allocated to the n batteries 101 is equal to a total charge power.

The second battery charge unit 503 is configured to each power regulation module 102 to charge a corresponding battery 101 with an electric energy output by a power grid 105 in accordance with a charge power allocated to the corresponding battery 101.

In a possible embodiment, the second power allocation unit 502 is specifically configured to determine, when the state-of-charge data of various batteries 101 are not equal and the state-of-heath data of various batteries 101 are not equal, an allocation ratio of charge power for each battery 101 according to a formula SOC₁×(1−SOH₁)×W₁₌SOC₂×(1−SOH₂)×W₂= . . . =SOCₙ×(1−SOHₙ)×Wₙ, where, SOC₁ is a state-of-charge data of a first battery 101; SOH₁ is a state-of-heath data of a first battery 101; W₁ is an allocation ratio of charge power for the first battery 101; SOC₂ is a state-of-charge data of a second battery 101; SOH₂ is a state-of-heath data of the second battery 101; W₂ is an allocation ratio of charge power for the second battery 101; SOCₙ is a state-of-charge data of a n^{th} battery 101; SOHₙ is a state-of-heath data of the n^{th} battery 101; and Wₙ is an allocation ratio of charge power for the n^{th} battery 101.

In a possible embodiment, the second power allocation unit 502 is further specifically configured to determine, when the state-of-charge data of various batteries 101 are equal and the state-of-heath data of various batteries 101 are not equal, an allocation ratio of discharge power for each battery 101 according to a formula (1−SOH₁)×K₁=(1−SOH₂)×K₂= . . . =(1−SOHₙ)×Kₙ, where SOH₁ is a state-of-heath data of a first battery 101; k₁ is an allocation ratio of discharge power for the first battery 101; SOH₂ is a state-of-heath data of a second battery 101; k₂ is an allocation ratio of discharge power for the second battery 101; SOCₙ is a state-of-charge data of a n^{th} battery 101; and kₙ is an allocation ratio of discharge power for the n^{th} battery 101.

In a possible embodiment, the second power allocation unit 502 is further specifically configured to determine, when the state-of-heath data of various batteries 101 are equal and the state-of-charge data of various batteries 101 are not equal, an allocation ratio of discharge power for each battery 101 according to a formula SOC_{1×}K₁−SOC₂×K₂= . . . SOCₙ×Kₙ, where SOC₁ is a state-of-charge data of a first battery 101; k₁ is an allocation ratio of discharge power for the first battery 101; SOC₂ is a state-of-charge data of a second battery 101; k₂ is an allocation ratio of discharge power for the second battery 101; SOCₙ is a state-of-charge data of a n^{th} battery 101; and kₙ is an allocation ratio of discharge power for the n^{th} battery 101.

In the above description, the technical details such as compositions of each layer are not explained in detail. However, those skilled in the art should understand that various technical means may be used to form layers, regions and so on with desired shapes. Further, in order to form a same structure, those skilled in the art may also design a method that is not completely the same as the method described above. Furthermore, although various embodiments have been described above separately, this does not mean that measures in the various embodiments cannot be advantageously used in combination.

Although preferred embodiments of the disclosure have been described, additional changes and modifications may be made to these embodiments once those skilled in the art are aware of the basic inventive concepts. Therefore, it is intended that the appended claims are interpreted as including the preferred embodiment as well as all changes and modifications that fall within the scope sought by the disclosure.

Obviously, those skilled in the art can make various changes and modifications to the disclosure without departing from the spirit and scope of the disclosure. Thus, if these modifications and variations of the disclosure fall within the scope of the claims of the disclosure and equivalent technologies thereof, the disclosure is also intended to include these modifications and variations.

What is claimed is:

1. A household load power supply method, applied to a central controller which belongs to a household load power supply system, wherein the household load power supply system further comprises n power supply branches in parallel, each of which comprises a battery and a power regulation module that are connected in series; the central controller is electrically connected to each power regulation module, respectively, n being an integer greater than 1;
and the method comprises:
obtaining, by the central controller when receiving a discharge instruction transmitted by a user terminal, state-of-charge data and state-of-heath data of n batteries;
allocating, by the central controller according to a required total discharge power and the state-of-charge data and state-of-heath data of n batteries, a discharge power for each battery, wherein the discharge power for each battery is proportional to the state-of-charge data and state-of-heath data of each battery; and a sum of discharge powers allocated to the n batteries is equal to the total discharge power; and
controlling, by the central controller, each power regulation module to make a corresponding battery to discharge to a power grid in accordance with a discharge power allocated to the corresponding battery.

2. The method according to claim 1, wherein the allocating, by the central controller according to the required total discharge power and the state-of-charge data and state-of-heath data of the n batteries, the discharge power for each battery, comprises:
determining, by the central controller when the state-of-charge data of various batteries are not equal and the state-of-heath data of various batteries are not equal, an allocation ratio of discharge power for each battery according to a formula (1−SOC₁×SOH₁)×K₁=(1−SOC_{2×}SOH₂)×K₂= . . . =(1−SOCₙ×SOHₙ)×Kₙ, where, SOC₁ is a state-of-charge data of a first battery; SOH₁ is a state-of-heath data of the first battery; k₁ is an allocation ratio of discharge power for the first battery; SOC₂ is a state-of-charge data of a second battery; SOH₂ is a state-of-heath data of the second battery; k₂ is an allocation ratio of discharge power for the second battery; SOCₙ is a state-of-charge data of a n^{th} battery; SOHₙ is a state-of-heath data of the n^{th} battery; and kₙ is an allocation ratio of discharge power for the n^{th} battery; and
allocating the discharge power for each battery according to the allocation ratio of discharge power for each battery and the total discharge power.

3. The method according to claim 2, wherein the determining, by the central controller according to the formula (1−SOC₁×SOH₁)×K₁=(1−SOC_{2×}SOH₂)×K₂= . . . =(1−SOC)×SOHₙ)×Kₙ, the allocation ratio of discharge power for each battery comprises:
determining, by the central controller according to the formula (1−SOC₁×SOH₁)×K₁=(1−SOC_{2×}SOH₂)×K₂= . . . =(1−SOCₙ×SOHₙ)×Kₙ, an allocation ratio of discharge current/discharge voltage for each battery; and
determining, by the central controller, the allocation ratio of discharge current/discharge voltage for each battery as the allocation ratio of discharge power for each battery.

4. The method according to claim 1, wherein the allocating, by the central controller according to the required total discharge power and the state-of-charge data and state-of-heath data of the n batteries, the discharge power for each battery comprises:
determining, by the central controller when the state-of-heath data of various batteries are equal and the state-of-charge data of various batteries are not equal, an allocation ratio of discharge power for each battery according to a formula (1−SOC₁)×K₁−(1−SOC₂)×K₂= . . . =(1−SOCₙ)×Kₙ, where SOC₁ is a state-of-charge data of a first battery; k₁ is an allocation ratio of discharge power for the first battery; SOC₂ is a state-of-charge data of a second battery; k₂ is an allocation ratio of discharge power for the second battery; SOCₙ is a state-of-charge data of a n^{th} battery; and kₙ is an allocation ratio of discharge power for the n^{th} battery.

5. The method according to claim 1, wherein the allocating, by the central controller according to the required total discharge power and the state-of-charge data and state-of-heath data of the n batteries, the discharge power for each battery comprises:
determining, by the central controller when the state-of-charge data of various batteries are equal and the state-of-heath data of various batteries are not equal, an allocation ratio of discharge power for each battery according to a formula (1−SOH₁)×K₁=(1−SOH₂)×K₂= . . . =(1−SOHₙ)×Kₙ, where SOH₁ is a state-of-heath data of a first battery; k₁ is an allocation ratio of discharge power for the first battery; SOH₂ is a state-of-heath data of a second battery; k₂ is an allocation ratio of discharge power for the second battery; SOHₙ is a state-of-heath data of a n^{th} battery; and kₙ is an allocation ratio of discharge power for the n^{th} battery.

6. A battery charge method, applied to a central controller which belongs to a household load power supply system, wherein the household load power supply system further comprises n power supply branches in parallel, each of which comprises a battery and a power regulation module that are connected in series; the central controller is electrically connected to each power regulation module respectively, n being an integer greater than 1;
and the method comprises:
obtaining, by the central controller when receiving a charge instruction transmitted by a user terminal, state-of-charge data and state-of-heath data of n batteries;
allocating, by the central controller according to a required total charge power and the state-of-charge data and state-of-heath data of n batteries, a charge power for each battery, wherein the charge power for each battery is inversely proportional to the state-of-charge data and the charge power for the each battery is proportional to state-of-heath data of the each battery; and in a sum of charge powers allocated to the n batteries is equal to a total charge power; and
controlling, by the central controller, each power regulation module to charge a corresponding battery with an electric energy output by a power grid in accordance with a charge power allocated to the corresponding battery.

7. The method according to claim 6, wherein the allocating, by the central controller according to the required total charge power and the state-of-charge data and state-of-heath data of the n batteries, the charge power for each battery comprises:
determining, by the central controller when the state-of-charge data of various batteries are not equal and the state-of-heath data of various batteries are not equal, an allocation ratio of charge power for each battery according to a formula SOC₁×(1−SOH₁)×W₁=SOC₂×(1−SOH₂)×W₂= . . . =SOCₙ×(1−SOHₙ)×Wₙ, where, SOC₁ is a state-of-charge data of a first battery; SOH₁ is a state-of-heath data of the first battery; W₁ is an allocation ratio of charge power for the first battery; SOC₂ is a state-of-charge data of a second battery; SOH₂ is a state-of-heath data of the second battery; W₂ is an allocation ratio of charge power for the second battery; SOCₙ is a state-of-charge data of a n^{th} battery; SOHₙ is a state-of-heath data of the n^{th} battery; and Wₙ is an allocation ratio of charge power for the n^{th} battery.

8. The method according to claim 6, wherein the allocating, by the central controller according to the required total charge power and the state-of-charge data and state-of-heath data of the n batteries, the charge power for each battery comprises:
determining, by the central controller when the state-of-charge data of various batteries are equal and the state-of-heath data of various batteries are not equal, an allocation ratio of charge power for each battery according to a formula (1−SOH₁)×W₁=(1−SOH₂)×W₂= . . . =(1−SOHₙ)×Wₙ, where SOH₁ is a state-of-heath data of a first battery; W₁ is an allocation ratio of charge power for the first battery; SOH₂ is a state-of-heath data of a second battery; W₂ is an allocation ratio of charge power for the second battery; SOCₙ is a state-of-charge data of a n^{th} battery; and Wₙ is an allocation ratio of charge power for the n^{th} battery.

9. A household load control apparatus, comprising a household load power supply device, configured at a central controller which belongs to a household load power supply system, wherein the household load power supply system further comprises n power supply branches in parallel, each of which comprises a battery and a power regulation module that are connected in series; the central controller is electrically connected to each power regulation module respectively, n being an integer greater than 1; and the household load power supply device comprises:
a first data acquisition unit, configured, when receiving a discharge instruction transmitted by a user terminal, to obtain state-of-charge data and state-of-heath data of n batteries;
a first power allocation unit, configured to allocate a discharge power for each battery according to a required total discharge power and the state-of-charge data and state-of-heath data of n batteries, wherein the discharge power for each battery is proportional to the state-of-charge data and state-of-heath data of the each battery; and a sum of discharge powers allocated to the n batteries is equal to the total discharge power; and
a first battery discharge unit, configured to control each power regulation module to make a corresponding battery to discharge to a power grid in accordance with a discharge power allocated to the corresponding battery.

10. The household load control apparatus according to claim 9, further comprising a battery charge device, configured at the central controller, and wherein the battery charge device comprises:
a second data acquisition unit, configured, when receiving a charge instruction transmitted by a user terminal, to obtain state-of-charge data and state-of-heath data of n batteries;
a second power allocation unit, configured to allocate a charge power for each battery according to a required total charge power and the state-of-charge data and state-of-heath data of n batteries, wherein the charge power for the each battery is inversely proportional to the state-of-charge data of the each battery and the charge power for the each battery is proportional to the state-of-heath data of the each battery; and a sum of charge powers allocated to the n batteries is equal to a total charge power; and
a second battery charge unit, configured to control each power regulation module to charge a corresponding battery with an electric energy output by a power grid in accordance with a charge power allocated to the corresponding battery.
